(19) United States
(12) Patent Application Publication
(10) Pub. No.: US 2016/0267571 A1
(43) Pub. Date: Sep. 15, 2016

(54) SYSTEM AND METHOD FOR CLASSIFYING FOOD PRODUCTS

(71) Applicant: SOFTMATE TECHNOLOGIES INC., Québec (CA)

(72) Inventors: Daniel FUGÈRE, Blainville (CA); Patrick CHASSÉ, Laval (CA); Jean BOUCHARD, Lachenaie (CA); Marc ROY, Mascouche (CA)

(21) Appl. No.: 15/028,304

(22) PCT Filed: Oct. 9, 2014
(86) PCT No.: PCT/CA2014/050980

§ 371 Date: Apr. 8, 2016

Related U.S. Application Data
(60) Provisional application No. 61/888,701, filed on Oct. 9, 2013.

(51) Int. Cl. G06Q 30/06; G06Q 50/12

(52) U.S. Cl. CPC G06Q 30/0629; G06Q 50/12; G06Q 30/0627

(57) ABSTRACT

A system and method for classifying food products is disclosed, as well as to an associated processor-readable storage medium. Selected attributes defining sensory properties of a food product is received. The food products may be a beverages for example, such as wines. Each selected attribute is then correlated to a value. The values of the attributes are transformed into a digest code. The digest code is a condensed and unique representation of the unique combination of said selected attributes defining the sensory properties and is stored in association with the food product.

### FIELD OF THE INVENTION

The present relates to the field of classifying food products, and more particularly, to a system and method for classifying food products, including beverages such as wines, as well as to an associated processor-readable storage medium.

### BACKGROUND OF THE INVENTION

Known in the art are various systems for classifying food products, including beverages such as wine or the like.

Known to the applicant, in the area of wine classification, are U.S. Pat. No. 8,364,545 B2; and No. 7,124,035 B1; and U.S. patent applications No. 2012/0226698 A1; No. 2009/0210321 A1; No. 2012/0284129 A1; No. 2006/0179055 A1; No. 2009/0055247 A1; No. 2013/0080438 A1; No. 2013/0332809 A1; and 2014/0019296 A1; and Canadian patent application No. 2783493; and German patent application No. 19638548 A1.

Conventional classification systems present several drawbacks. For example, most current systems offer a score, instead of an indication on the flavour characteristics. Other qualitative classification systems are too broad as they provide very general indications on flavour (for example, fruity versus dry). Foods such as wine products have varying flavours which are defined by numerous flavour properties, and consequently, a multitude of combinations of these properties are possible. It is therefore a challenge to comprehensively represent each of those combinations.

In light of the above, there is a need for an improved classification system and method for food, which focuses on the food's taste and which is comprehensive to consumers.

### SUMMARY OF THE INVENTION

An object of the present invention is to provide a classification system for food products, including beverages, such as wines for example, which defines flavour characteristics of a food product and which provides a comprehensible indication of the combination of flavour characteristics defined.

In accordance with an aspect of the present, there is provided a method for classifying food products, comprising the steps of: receiving, in a memory, selected attributes defining sensory properties of one of said food products; correlating, by means of a processor, each selected attribute to a value; transforming the values of the attributes into a digest code, by means of a calculator embedded in the processor, the digest code being a condensed and unique representation of the unique combination of said selected attributes defining the sensory properties; and storing in the memory, the digest code in association with the food product.

The digest code may comprise alpha-numerical characters. For example, the digest code may be defined by five alpha-numerical characters. Alternatively, the digest code may be represented by a bar-code and/or any other suitable format.

According to a particular embodiment, the correlating step comprises for each selected attribute: assigning an initial value to the selected attribute; scaling said initial value to a scaled value; and setting said value of the selected attribute to the corresponding scaled value.

According to a particular embodiment, the correlating step further comprises: defining parameters to characterize said sensory properties of the food product; and defining a set of possible attributes for each parameter, the possible attributes of a given parameter being mutually exclusive for a given food product, each possible attribute being associated to a position within the set of possible attributes. In this embodiment, the initial value to be scaled is determined based on the position of the corresponding selected attribute within the set of possible attributes.

According to a particular embodiment, the afore-mentioned initial value is obtained by: providing a reference table in a memory associating each possible attribute to a unique numerical value; mapping each of the selected attributes to a unique numerical value based on the reference table; and obtaining said initial value to be scaled, for each selected attribute, from the position of the numerical value within the list of numerical values associated in the reference table with the set of possible attributes for the corresponding parameter.

According to a particular embodiment, the afore-mentioned scaling comprises: defining a set of scaled values for each set of possible attributes, each scaled value being associated to a position within the set of scaled values; and for each selected attribute, retrieving the scaled value having a same position in the set of scaled values as the position of the selected attribute within the set of possible attributes of the parameter associated to the selected attribute.

According to a particular embodiment, the afore-mentioned step of defining the set of scaled values comprises: for a first set of scaled values, setting each scaled value to the position of the scaled value within the set; and for each subsequent set of scaled values, setting the first scaled value to the maximum scaled value of the previous set MAX_{PRECEDING SET} incremented by one, and setting each following scaled value to a sum of the maximum of the previous set MAX_{PRECEDING SET} and of the previous scaled value.

According to a particular embodiment, the afore-mentioned transforming step comprises summating the scaled values to obtain the digest code. The transforming may further comprises converting a sum of the scaled values resulting from the summating step, in order to reduce the expression of the digest code. For example, the sum of the scaled values may be converted from a decimal numeral system to a base 36 system.

According to a particular embodiment, the sensory properties may include any one or more of: flavor properties, scent properties, visual properties, and texture properties.

According to a particular embodiment, the digest code comprises a base component representing said selected attributes. The base component may comprise 4 to 5 characters, preferably alpha-numerical characters. The method may further comprise receiving additional selected attributes defining auxiliary sensory properties of said food product, wherein the digest code further comprises an auxiliary component concatenated to the base component representing a unique combination of the additional attributes having been selected to define the food product. The auxiliary component may comprise 1 or 2 characters, preferably alpha-numerical characters. Preferably, the auxiliary component is represented with a visual separation from the base component, for example with a hyphen or other suitable symbol. The digest code may further comprise a variation component representing a variation of a food product in relation to other food products sharing similar ones of said selected attributes.

According to a particular embodiment, the food products are wines. The sensory properties may include visual parameters comprising: Main Color (MC), Secondary Color (SC), Glint (G) and Tint (T), wherein each visual parameter is defined by possible attributes. The sensory properties may include flavor parameters comprising: Gentleness (Gs), Whole (W) and Acidity (A); Alcohol (Al), Flesh (F), Tannin (Tn), Aroma (Ar), and Persistence (P), wherein each of said flavor parameters are defined by possible attributes. The sensory properties may include one or more scent parameter comprising: an Olfactory family (O) parameter, wherein said scent parameter is defined by possible attributes. The possible attributes of the Olfactory family (O) parameter may be selected in combination with one another. The one or more scent parameter may further comprise: Cleanness (C); Intensity (I); Quality (Q).

According to a particular embodiment where the food products are wines, the sensory properties may include one or more flavor parameter, the digest code comprising a base component representing the selected attributes of said one or more flavor parameter. The method may further include: receiving additional attributes selected, the additional attributes defining one or more main scent parameter, and in which the digest code further comprises an auxiliary component concatenated to said base component, the auxiliary component representing a unique combination of the additional attributes having been selected to define the scent of the wine.

According, to this embodiment, the method may further include: receiving supplementary attributes selected, the supplementary attributes defining one or more supplementary scent parameter, in which the digest code further comprises a variation component which represents a variation in the particular wine, in relation to other wines sharing a portion of the selected attributes and additional attributes selected (for example having the same flavor properties and olfactory family attributes, but where the intensity (I) and/or quality (Q) parameter(s) of the ScentPrint is/are different). In this embodiment, the main scent parameter may comprise an Olfactory family (O) parameter, which may include any one or more of the following scent categories: Fruit, Floral, Vegetal, Torrefaction, Spice, Animal, and Defect. The scent parameters may define possible attributes which are combinable. The method may further include: providing in the memory a reference value for each possible combination of said additional attributes; and transforming said reference value to obtain the second component of the digest code. The reference value may be a numeric value and the above-mentioned transforming step may comprise converting the numeric value into a base 36 system value.

In accordance with another aspect, there is provided a processor-readable storage medium for classifying food products, the processor-readable product comprising data and instructions for execution by a processor, to execute the steps of the above-mentioned method. In a particular embodiment, the processor-readable storage medium is a non-transitory product.

In accordance with another aspect, there is provided a system for classifying food products, the system comprising: a memory for receiving selected attributes defining sensory properties of each of said food products; a processor being in communication with the memory for correlating each selected attribute of said food product, to a value; and a calculator embedded in the processor, for transforming the values of the selected attributes of said food product, in order to represent the unique combination of said selected attributes into a condensed and unique digest code to be stored in the memory in association with the food product. In a particular embodiment, the system further comprises a user interface device adapted to communicate with the processor, in order to display said digest code in association with the food product.

The objects, advantages and features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a schematic representation of a food classification system for wines, according to an embodiment of the present invention.

FIG. 2 is a screenshot of a tasting note for a wine expert user profile, provided by a user interface of the food classification system shown in FIG. 1, the screenshot showing a Product Information form.

FIG. 3 is another screenshot of the tasting note shown in FIG. 2, the screenshot showing an Olfactory Observations form.

FIG. 4 is another screenshot of the tasting note shown in FIG. 2, the screenshot showing a Taste Observation form.

FIG. 5 is another screenshot of the tasting note shown in FIG. 2, the screenshot showing a Food Pairing form.

FIG. 6 is another screenshot of the tasting note shown in FIG. 2, the screenshot showing a Comments form.

FIG. 7 is another screenshot of the user interface in the food classification system of FIG. 1, the screenshot showing a main screen within a consumer space.

FIG. 8 is another screenshot of the consumers user interface, the screenshot showing a list of wines having been evaluated by a particular wine expert.

FIG. 9 is another screenshot of the consumer's user interface, the screenshot showing an information window for a particular selected wine product.

FIG. 10 is another screenshot of the consumer's user interface, the screenshot showing a form for entering consumer appreciation information.

FIG. 11 is another screenshot of the consumers user interface, the screenshot showing a form for obtaining a wine, pairing based on a food entry.

FIG. 12 is a schematic representation of a table stored in a database of the classification system shown in FIG. 1.

FIG. 13 is a screenshot of a tasting note for a wine expert user profile, provided by a user interface of a food classification system in accordance with another embodiment, the screenshot showing a Product Information form.

FIG. 14 is another screenshot of the tasting note shown in FIG. 13, the screenshot showing an Olfactory Observations form.

FIG. 15 is another screenshot of the tasting note shown in FIG. 13, the screenshot showing a Taste Observation form.

FIG. 16 is another screenshot of the tasting note shown in FIG. 13, the screenshot showing a Food Pairing form.

FIG. 17 is another screenshot of the tasting note shown in FIG. 13, the screenshot showing a Comments form.

### DETAILED DESCRIPTION OF PREFERRED EMBODIMENTS OF THE INVENTION

In the following description, the same numerical references refer to similar elements. The embodiments mentioned and/or geometrical configurations and dimensions shown in the figures or described in the present description are embodiments of the present invention only, given for exemplification purposes only.

Broadly, the food classification system, according to a particular embodiment of the present invention provides a classification system for beverages, such as wines for example, which is useful to consumer in that the classification succinctly represents a taste and other sensory factors of the beverage, irrespectively of brand, age, originating region, grape variety, etc.

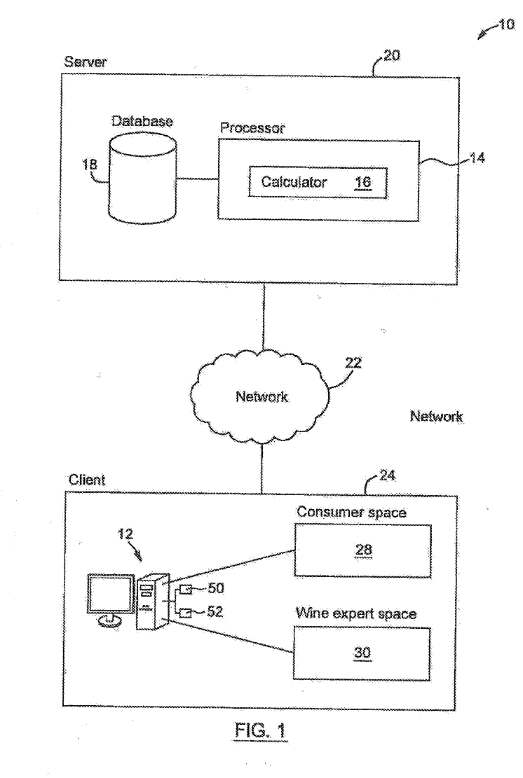

Thus, as better illustrated in FIG. 1, there is provided a classification system 10 for wine products, comprising:
a user interface 12 for receiving attributes defining flavour properties of one of said food products;
a processor 14 being in communication with the user interface 12, for correlating each attribute to a unique value;
a calculator 16 embedded in the processor 14, adapted to calculate a unique global value, by performing mathematical operations on the attribute values, such that the unique total value is representative of the unique combination of flavour properties defined by the attributes; and
a database 18 for storing the unique global value in association with the food product, to be output on the user interface 12.

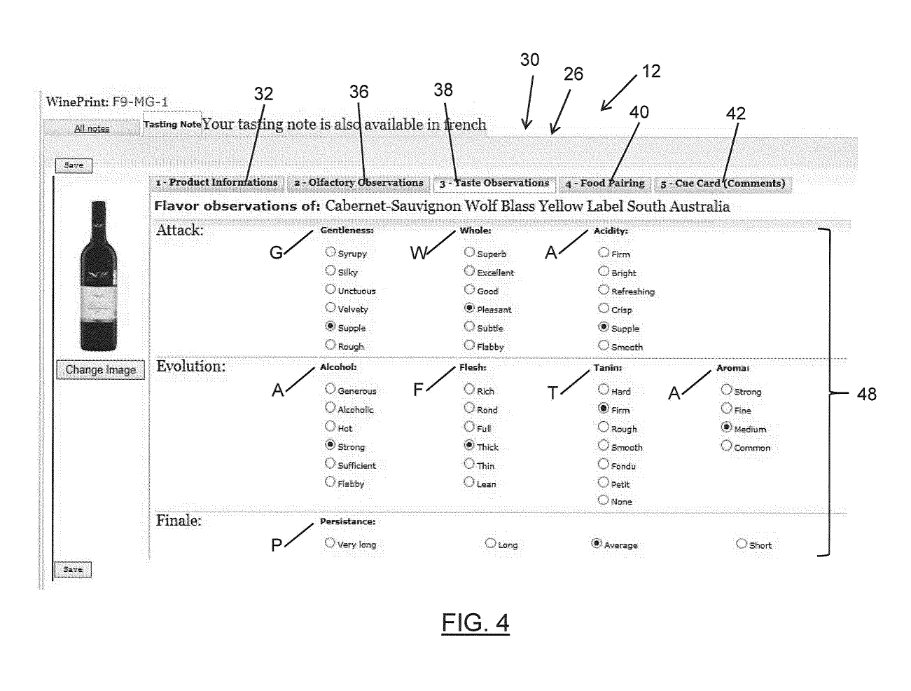

Attributes may include, for example, a “Supple” gentleness, a “Strong” alcohol level, and “Average” persistence level, as exemplified in FIG. 4.

The “unique global value” which represents the unique combination of flavour properties of a wine, is provided by a “WinePrint Number” (WPN)—also referred to as a “TastePrint Number” (TPN)—, in the context of the present embodiment. Moreover, a WinePrint (WP)—also referred to as a TastePrint (TP)—represents not only the combination of flavour properties but also additional attributes of a given set of wines.

### System Architecture

In accordance with the embodiment described and illustrated herein, the system 10 is provided by a client-system architecture on a web-based platform, as better illustrated in FIG. 1.

More particularly, the server 20 comprises the database 18 for the data storage, and further comprises functional modules embedded in the processor 14, for providing services, such as accessing the database 18, as will be better understood in light of the present description of embodiments. The server 20 is provided by a general purpose computer device.

It is to be understood that the server 20 may be provided by any other suitable computer device, in accordance with alternate embodiments. It is to be understood also that the server may be provided by a plurality of such computer devices, which are in communication with one another and may be adapted to cooperate together in order to provide the previously mentioned functional modules. The server is connected to a client-side device, via a data communication network 22.

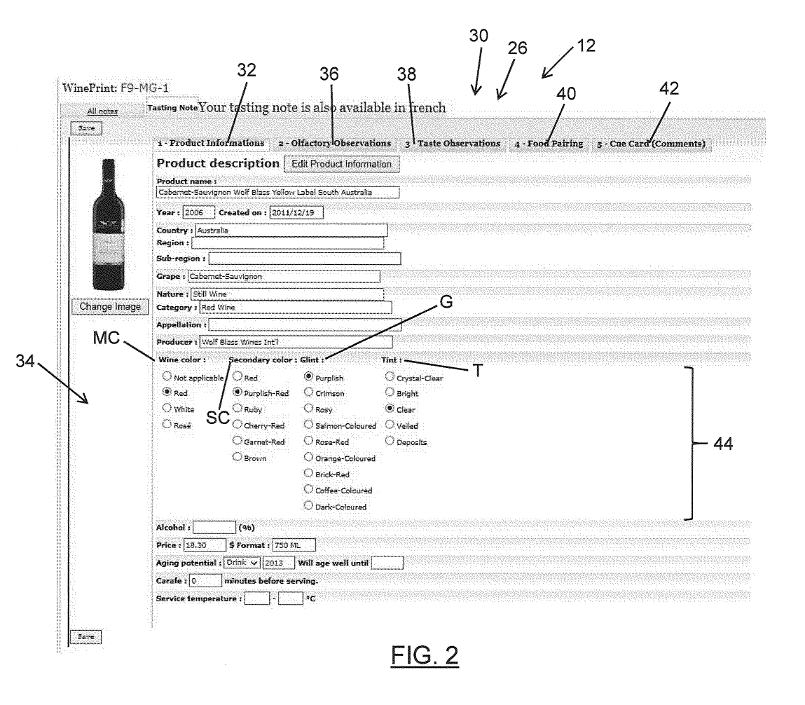

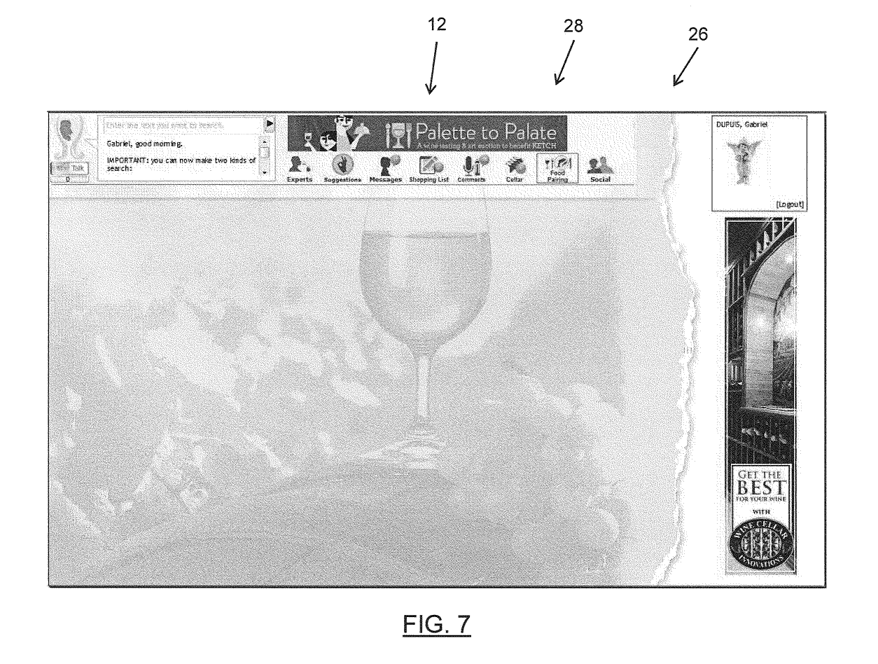

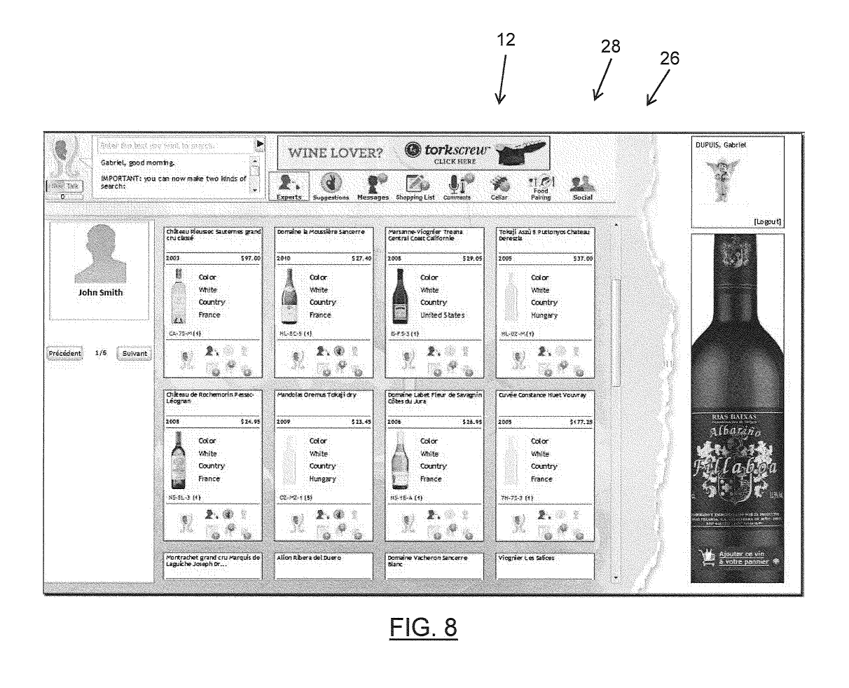

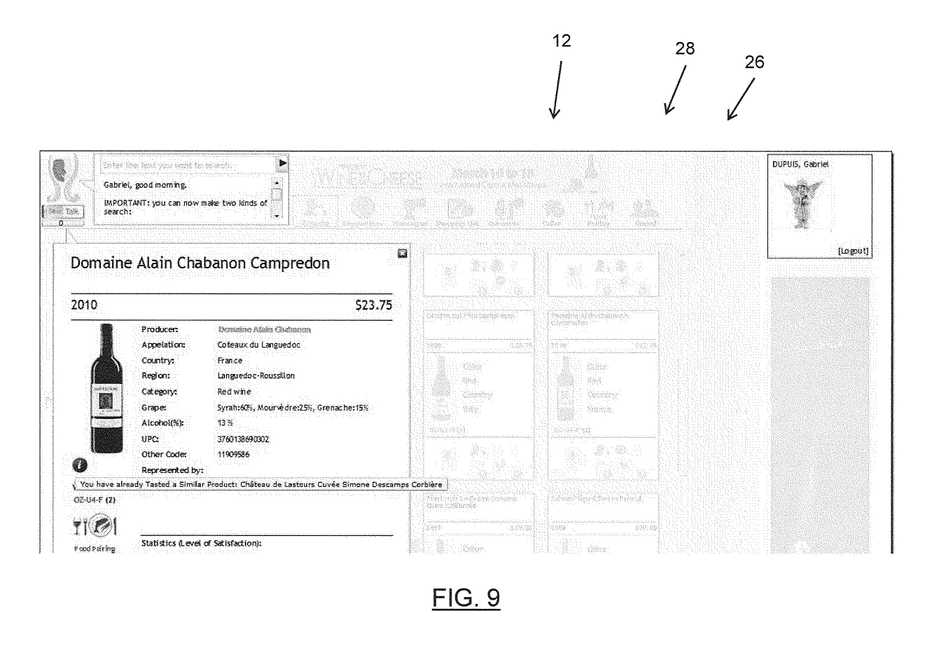

Referring back to FIG. 1, the client 24 is also provided by a computer device, such as a conventional computer, a tablet computer, a smart phone and/or other any suitable computer device(s). The client 24 provides the user interface 12, via a web browser or web-based application, in accordance with the embodiment described herein. For example, the user interface 12 may be accessible via a website (for conventional computers) or via a dedicated application on a tablet computer or smartphone. From the client device 24, a user (wine expert, consumer, retailer, or other) must enter authentication information to access functional features of the system. The functional features the user is given access to, may depends on the profile of the user. Thus, wine experts, consumers, retailers, each have different sets of functional features. Thus, the user interface's 12 web-based platform 26 offers a consumers' space 28 (see FIGS. 7 to 11), a wine experts' space 30 for entering tasting notes, etc. (see FIGS. 2 to 6), and some additional web services for specific requirements of participants (for example, social networking features, etc.).

In accordance with the present embodiment, the data communication network 22 is provided by the Internet. In alternative embodiments, the data communication network may be provided by any suitable communication network, such as cellular wireless network and conventional telephone (“land line”) network, and/or other.

The user interface 12 further provides social media features such as operational modules for sharing comments, appreciation information, etc. (either broadcasting at large, or to a community of users, e.g. “friends”). The wine experts and other stakeholders may also share their comments or other information with followers (consumers, retailers, other wine experts and/or other stakeholders).

The system's user interface 12 also comprises speech recognition features, with reference to FIG. 1, via a microphone 50, and voice synthesis output, via a sound output component such as a speaker 52, in order to allow users to interact with the system using voice. It is to be understood that users may also interact with the system via text entry, mouse, and/or other conventional user interface methods.

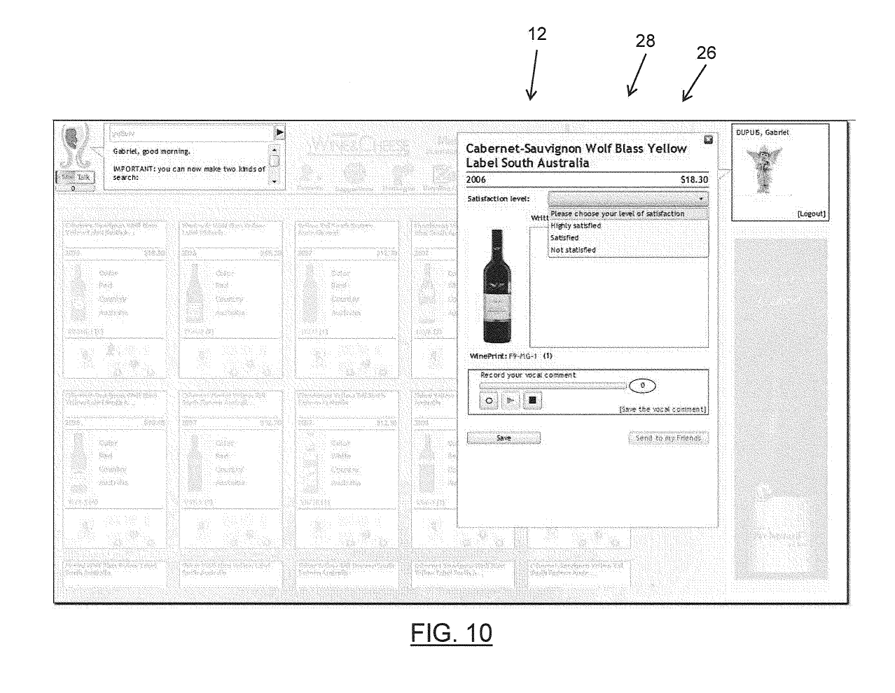

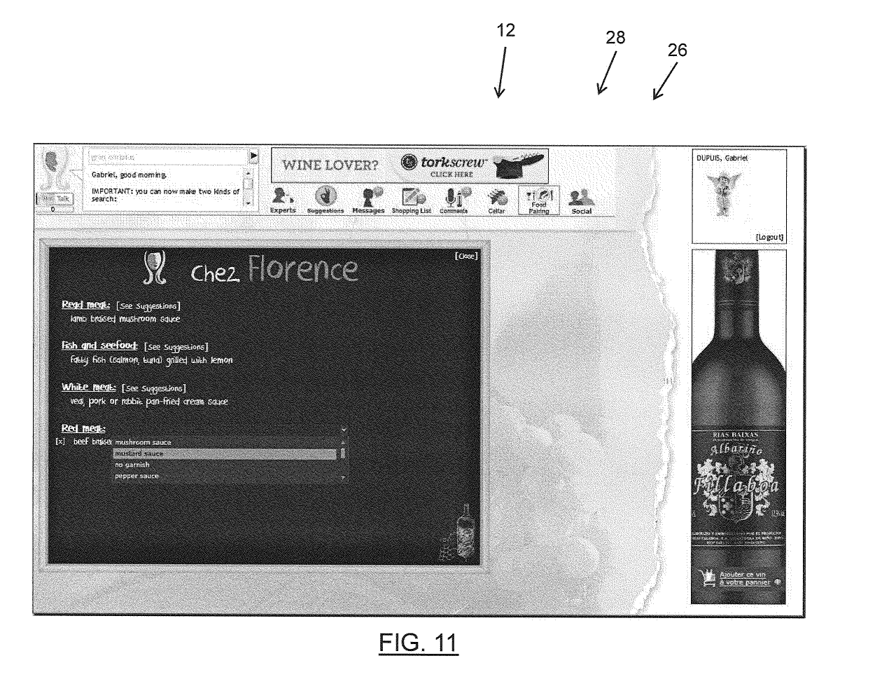

The system is also provided with artificial intelligence and learning features. For example, each time a consumer expresses his/her level of satisfaction (see entry form in FIG. 10) regarding a particular product, the system records this information in the database in association with, the corresponding WPN. When the consumer subsequently browses a product belonging to the same WPN, the system retrieves the consumer's appreciation information regarding this WPN (i.e. the level of satisfaction the consumer expressed) and informs him/her accordingly. Thus, the system learns from the consumer experiences and may further use this information to guide the consumer in a food/wine pairing session (see FIG. 11), to show appreciation information of a product suggested by a friend, etc.

The previously mentioned WinePrint (WP) and WinePrint Number (WPN)—or TastePrint (TP) and TastePrint Number (TPN), respectively—will now be better explained.

### WinePrint (or TastePrint)

Briefly, a WinePrint (WP or TP) is a succinct representation of various parameters entered in a wine tasting note. A “wine tasting note” in the context of the present description defines different parameters of a particular wine. Each WinePrint is generated, via a dedicated space 30 of the website 26 (see FIGS. 2 to 6) whereby wine experts make entries, including sensory properties. The WinePrint comprises a “ColorPrint” 44, a “ScentPrint” 46 and a “FlavourPrint” 48 representing the visual, olfactory and taste aspects, respectively, of a wine product.

A WinePrint Number (VPN or TPN) is an alphanumeric code representing one or more WinePrint including olfactory variations. Thus WPNs permit the classification of wine products having almost identical taste characteristics with a minimum number of symbols or characters.

In accordance with an embodiment of the present invention, the multitude of flavour attribute combinations are each represented by a WPN of five characters long. The WPN is generated based on operations performed on the attributes of the above-mentioned parameters, as will be better understood in light of the following explanations.

It is to be understood that, in accordance with alternative embodiments and depending on the particular manipulations made to the attribute input, the resulting WPN may be represented by fewer than five characters or by more than five characters. It is desirable for the representation to be as succinct as possible, all the while providing sufficient categories to distinguish each set of wines having similar flavour properties, in order to be useful to consumers.

The classification by VPN, in accordance with the present embodiment, is useful to consumers in that it focuses on taste and flavour, given that the vast majority of people cannot differentiate the taste between the various products categorized in a particular WPN. Thus, if a consumer appreciates a particular product, he/she is highly likely to enjoy all or at least most of the wines from this same WIN. And vice versa, if a consumer does not enjoy a particular wine product, he/she is likely to have the same appreciation for all or at least most wine products of the same WPN.

Advantageously, the WPN has great commercial value as it provides a new way of organizing the different wines, independently of grape varieties and originating regions. Any given WPN may encompass products from different countries and having very different sale prices, while having very similar taste and sensory properties.

In addition, according to a particular embodiment, the system collects the satisfaction level of consumers of various WPNs and may thus refer the various stakeholders to better target their markets.

The WPN and its derivatives will now be better described.

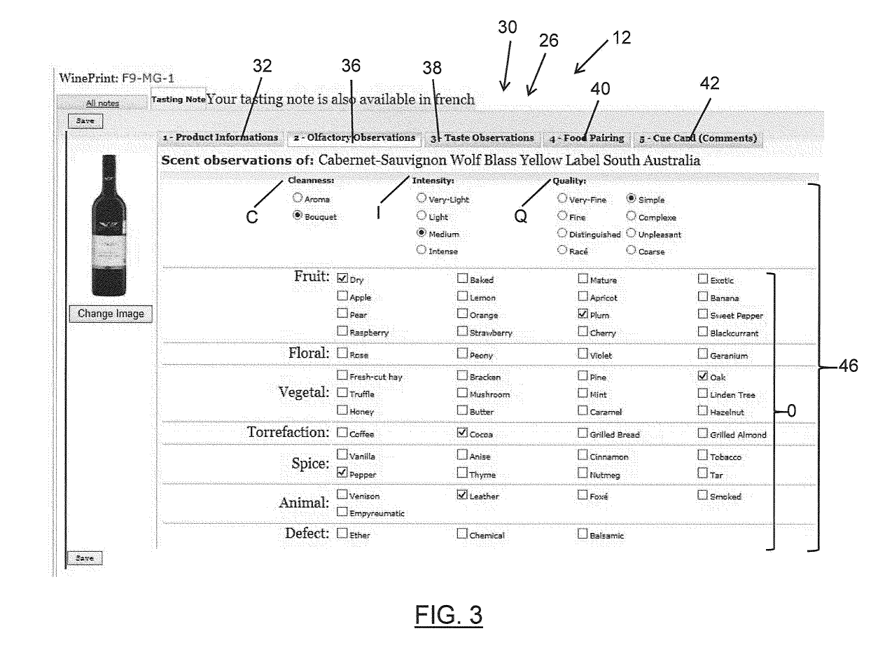

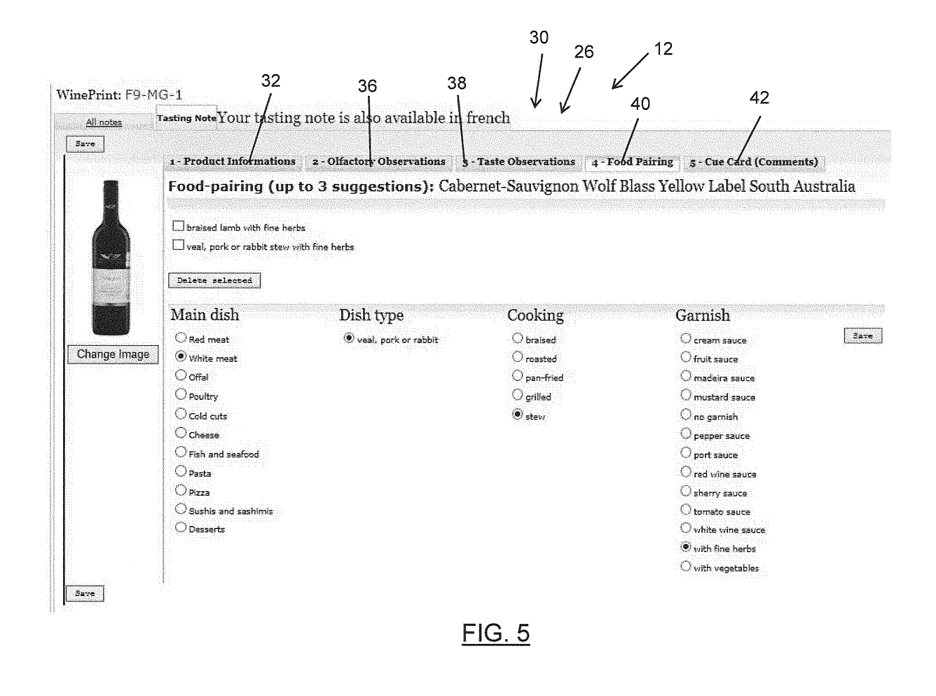

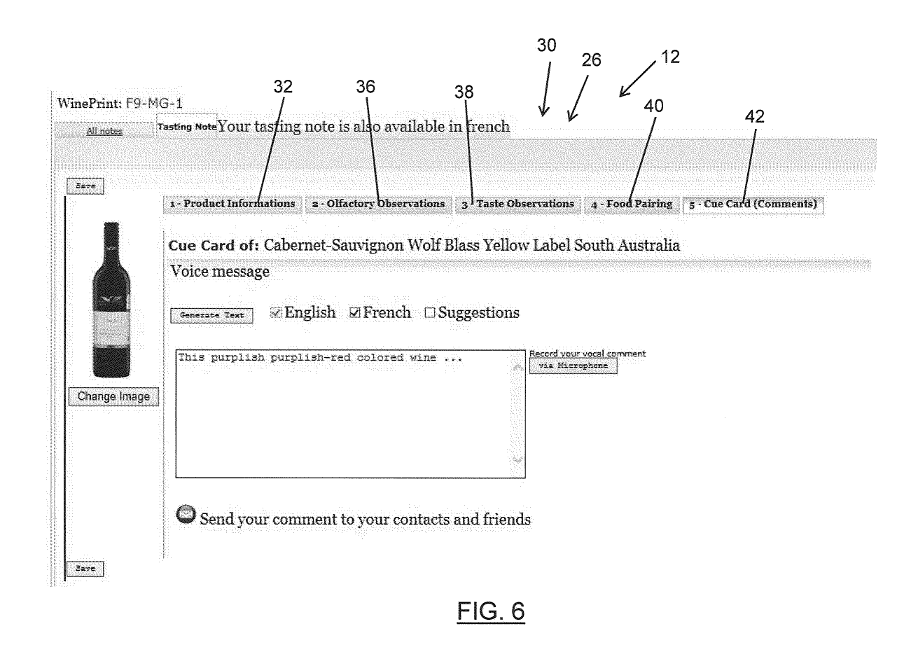

FIGS. 2 to 6 show data input screens of a tasting note for wine experts to build a WP for a particular wine product. The data input screens include a ‘General Information’ tab 32 (FIG. 2) which includes a Visual observations' section 34, an Olfactory observations' tab 36 (FIG. 3), a Taste Observation' tab 38 (FIG. 4), a ‘Food Pairing’ tab 40 (FIG. 5) and a ‘Comments’ tab 42 (FIG. 6).

The tasting note addresses various aspects of a wine tasting experience. In the present embodiment, only the notes on the visual aspect, on the scent aspect and on the flavour aspect are taken into consideration to produce a resulting WinePrint, that is to say, the ColorPrint 44, the ScentPrint 46 and FlavourPrint 48 make the WinePrint.

With reference to FIG. 2, the ColorPrint 44 represents a combination of color observation parameters, namely the following parameters: Wine Color or Main Color (MC), Secondary Color (SC), Glint (G) and Tint (T).

With reference to FIG. 3, the ScentPrint 46 represents a combination of olfactory observation parameters, namely the following parameters: Cleanness (C); Intensity (I); Quality (Q), Olfactory family (O) which may include any one or more of the following scents: Fruit, Floral, Vegetal, Torrefaction, Spice, Animal and Defect.

With reference to FIG. 4, the FlavourPrint 48 represents a combination of taste observation parameters. The taste is generally considered the most important aspect of the wine tasting note. Namely the FlavourPrint 48 parameters include:
for the attack: Gentleness (Gs), Whole (W) and Acidity (A);
for the evolution: Alcohol (Al), Flesh (F), Tannin (Tri), Aroma (Ar); and
for the finale: Persistence (P).

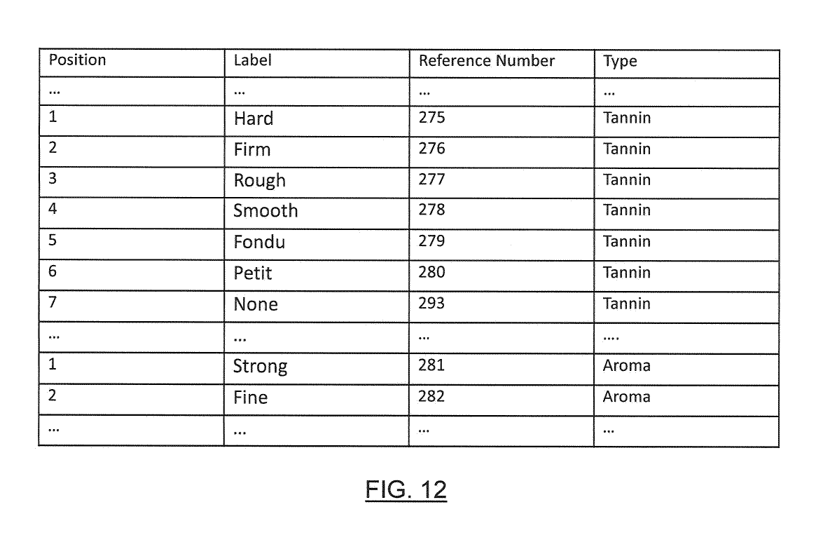

Each parameter value is represented numerically, based on a table of reference. FIG. 12 exemplifies a table of reference, showing a portion of its content.

As an example, for a given red wine having “red” for Wine Color (MC), “purplish-red” for secondary color (SC), “purplish” Glint (G), and “clear” Tint (T), the resulting ColorPrint is translated in the following representation MC:1˜SC:7˜G:10˜T:19, where “MC:1” means the Wine Color is “red”, “SC:7” means the Secondary Color is “purplish-red”, “G:10” means the Glint is “purplish” and “T:19” means the tint is “clear”. Each parameter and its value is separated by a “˜” character in order visually separate each parameter. The numeric values 1, 7, 10 and 19 originate from a unique sequential allocation respective to ColorPrint 44, ScentPrint 46 and FlavourPrint 48. Values are attributed similarly to ScentPrint and FlavourPrint.

For example, the 2006 Yellow Label™ which is an Australian red wine is attributed the following WinePrint components (with reference to FIGS. 2 to 4):

### ColorPrint 44: MC:118˜SC:121˜G:156˜T:169

### ScentPrint 46: C:179˜I:181˜Q:185˜O:286˜F:1

### FlavourPrint 48: Gs:247˜W:254˜A:262˜Al:263˜F:272˜Tn:276˜Ar:284˜P:286

The WinePrint is identified by concatenating each of: ColorPrint 44, ScentPrint 46 and FlavourPrint 48. Thus the WinePrint of the 2006 Yellow Label™ is identified as follows:

### MC:118˜SC:121˜G:156˜T:169

### +C:179˜I:181˜Q:185˜O:286˜F:1

### +Gs:247˜W:254˜A:262˜Al:263˜F:272˜Tn:276˜Ar:284˜P:286

The above-described representation is language independent, and thus provides a format which can be communicated in a universal manner. Moreover, the separation of each parameter by use of a symbol ˜ allows to easily search values by pattern matching.

The WinePrint is thus stored by ColorPrint 44, ScentPrint 46 and FlavourPrint 48 within a single table of the database, which is distinguishing from many known systems which usually classify the information separately in several tables.

### WinePrint Number (or TastePrint Number)

1) FlavourPrint

A WinePrint Number (WPN or TPN) is a digest of the above-mentioned WP (or TP). In order to obtain this WPN, a series of mathematical and algorithmic operations are applied to the FlavourPrint number. More particularly, each parameter of a FlavourPrint is represented by five to seven possible values. Each parameter's value is associated to a unique value through a mapping system.

Referring to the above-mentioned example of the Yellow Label™, the FlavourPrint is: Gs:247˜W:254˜A:262˜Al: 263˜F:272˜Tn:276˜Ar:284˜P:286). The component “Tn:276” signifies that the “reference number” associated to a “Firm” tannin is 276, as shown in the mapping table exemplified in FIG. 12. As shown in FIG. 4, the Tanin level of this wine is categorized as “firm”.

It is desirable for the WPN to be a unique representation having a minimum of characters. In addition, it is preferable to avoid defining too many WPN such that each WPN encompasses too few wine products, In order to establish a suitable WPN, the values of the eight parameters describing the FlavourPrint, namely Gentleness, Whole, Acidity, Alcohol, Flesh, Tannin, Aroma and Persistence, are taken into consideration.

1) Referencing Attributes of the FlavourPrint

Instead of adding all the reference numbers, which would result unnecessarily in a very large figure, and possibly not a unique number (for example, with different Aromas and Tannin levels: 281+276=282+275=557), the reference numbers are converted to a different scale, in order to obtain a unique number for each combination of parameters when they are added together.

2) Scaling the Reference Numbers

Firstly, each parameter is associated to a different set of values. The values in each set is chosen so that the sum of values corresponding to each combination of the FlavourPrint parameters results in a unique sum. Namely, the following set is attributed to the tannins: InSet={1,2,3,4,5,6,7}. Since the Tannin parameter may be defined by seven different attributes (“Hard”, “Firm”, “Rough”, “Smooth”, “Fondu”, “Petit” and “None”), the cardinality of this set is 7.

The subsequent sets for the other parameters are sequentially assigned, in accordance with the following logic:

For a given set, each value is greater than the maximal value of the preceding set.
Thus, the first value (V₁) of the set is V₁=1+MAX_{PRECEDING SET}
Subsequent values of this set are calculated as follows:

$${V}_{2} = {V}_{1} + {MAX}_{PRECEDING SET} , \\ {V}_{3} = {V}_{2} + {MAX}_{PRECEDING SET} , \\ …$$

$${V}_{n} = {V}_{n - 1} + {MAX}_{PRECEDING SET} ,$$

where n is the cardinality of the set.

Given an example where a first set S₁ has a cardinality of 3 and a second set S₂ also has a cardinality of 3, the set S₁ is defined by: S₁={1,2,3}, and the set S₂ is defined by S₂={4, 7, 10}, because:

V₁=1+MAX_{PRECEDING SET}=1+3=4;

V₂=V₁+MAX_{PRECEDING SET=}4+3=7;

V₃=V₂MAX_{PRECEDING SET=}7+3=10.

Thus each possible combination of S₁ value and S₂ value adds up to a unique sum. Namely:

where S₁=1 and S₂=4, then S₁+S₂=5;

where S₁=1 and S₂=7, then S₁+S₂=8;

where S₁=1 and S₂=10, then S₁+S₂=11;

where S₁=2 and S₂=4, then S₁+S₂=6;

where S₁=2 and S₂=7, then S₁+S₂=9;

where S₁=2 and S₂=10, then S₁+S₂=12;

where S₁=3 and S₂=7, then S₁+S₂=10;

where S₁=3 and S₂=10, then S₁+S₂=13.

Indeed, each of the sums 5, 8, 11, 6, 9, 12, 7, 10, 13 is a unique value and represents a unique combination from the sets S₁ and S₂.

A subsequent set S₃ would be determined as follows:

S₃={V₁=MAX_{S2}+1, V₂=MAX_{S2}, . . . }={11, 21, . . . }.

A similar logic is applied to generate the sets for each of the FlavourPrint parameters. Indeed, each parameter is associated to a set of values, wherein each value corresponds to an attribute of the parameter. The calculated sets of values correspond to the scaled down version of each reference number.

Secondly, each selected attribute is correlated to a value from the corresponding set, depending on its position (see “Position” in FIG. 12) in relation to the other attributes of the parameter (or “Type” in the table shown in FIG. 12). Thus, from the generated sets, the value associated to the position of each selected attribute is retained. For example, in the case of the Yellow Label™, the tannin level “Firm” is correlated to the value (or reference number) “276” which is in position 2 (see table extract in FIG. 12). As previously mentioned, the following set is attributed to the tannins: TnSet={1,2,3,4,5,6,7}. Therefore, the scaled value 2 is retained for the attribute “Firm Tannin”.

3) Summation of the Scaled Values

Each of the scaled values retained correspond to the selected attributes, and are then added together.

4) Conversion to Base 36

The total sum, which may be a substantially large number, is then converted to a base 36 (0-0, A-Z) system. In the case of the Yellow Label™, the summation of the scaled values, when converted, results in “F9-MG”.

5) ScentPrint

The WPN further contains information representing part of the ScentPrint. The olfactory properties of a wine are difficult to evaluate for some wine experts. Therefore, a margin of error of +/−1 for intensity (I) and +/−2 for quality (Q) is allowed. For example, where a ScentPrint represents an intensity level of “medium”, it also encompasses an intensity level of “light” or “intense” (one degree away from “medium”). In another example, where a ScentPrint comprises an intensity level of “intense”, it also encompasses an intensity level of “medium” (one degree away from “intense”), however “light” or “very-light” would not be encompassed as they are more than two degrees away from “intense”. In the case of Quality (Q), where a ScentPrint represents a quality level of “simple”, it also encompasses a quality level of “race” or “complex” (one degree away from “simple”) or a quality level of “distinguished” or “unpleasant” (two degrees away from “medium”).

Referring to FIG. 3, the ScentPrint of the Yellow Label™ is represented by

C:179˜I:181˜Q:185˜O:286˜F:1, as previously mentioned. The parameter F: represents the olfactory family. As can be seen in FIG. 3, each element (Dry, Apple, Pear, etc.) is characterized by seven families namely: Fruit, Floral, Vegetal, Torrefaction, Spice, Animal and Defect.

Moreover, the system defines four subsets of the “Fruit” and “Vegetal” olfactory families, namely:
Red Fruits: {Raspberry, Strawberry, Cherry, Blackcurrant, Plum and Sweet Pepper};
White Fruits: {Apple, Lemon, Apricot, Banana, Pear and Orange};
Exotic: {Exotic}; and
Sweet Vegetal: {Honey, Butter, Caramel and Hazelnut}.

The parameter F is thus defined based on this information. They are there to improve its accuracy in better discriminating which products should be part of a WPN. The system thus defines eleven families (i.e. Fruit, Floral, Vegetal, Torrefaction, Spice, Animal, Defect, Red Fruits, White Fruits, Exotic, Sweet Vegetal). In the Yellow Label, the F parameter is F:1 corresponding to the olfactory family (combination of Fruit, Vegetal, Torrefaction, Spice, Animal and the subset Red Fruits) represented in a base 36 system (0 to 9, A to Z), In the ScentPrint 46, “0:286” represents the specific combination of the qualities selected for each attribute of the Olfactory family (Fruit=Dry, Plum, Vegetal=Oak, Torrefaction=Cocoa, Spice=Pepper, Animal=Leather).

The WPN of the Yellow Label™ is thus: F9-MG-1, where the first four characters represent the FlavourPrint, and the last character “1” corresponds to the value of the “F” parameter in the ScentPrint.

In the event that a wine has the same FlavourPrint and the same parameter F of a reference wine, but where the parameters I (intensity) and Q (quality) of the ScentPrint is different (i.e. a gap greater than 1 for the intensity and/or a gap greater than 2 for quality), then a variation in the WinePrint is determined. The WPN corresponds to “F9-MG-1-1” for a first variation and to “F9-MG-1-2” for a second variation. A variation reflects differences in products sharing the same FlavourPrint but having different ScentPrints. When a FlavourPrint is created, the variation number is 0 and does not appear in the WPN. The first time the system encounters the FlavourPrint with a different SentPrint (where 1 and/or Q are different), it incrementally increases the variation number by one. Thus, when a first variation is detected, a “−1” in is concatenated to the initial WPN, and so on.

It is an object of the above-described embodiment to categorize wines in terms of WinePrint Number, while finding a practical balance between what may or may not constitute a wine classification category. For this reason, the WPN, in accordance with the embodiment described herein, considers only some of the parameters of the ScentPrint and is independent of the ColorPrint. Otherwise, there would be many more wine categories, as almost each brand of wine may correspond to a different WPN, which would render the classification system less comprehensive and eliminate correlations between wines of similar Flavour. Indeed, a useful classification of beverages, focused principally on taste experience is sought. It is desirable to have just enough categories for a WPN to reference a certain number of wines that will unanimously belong to a particular category. There may also be room for flexibility to adjust the wines which are encompassed in a given category.

It is to be understood however, that according to alternate embodiments, the WPN or equivalent identifier in the context of other food classification systems, may be designed to consider other sensory characteristics, such as color, texture, density, etc., as may be easily understood by a person skilled in the art, without departing from the present invention.

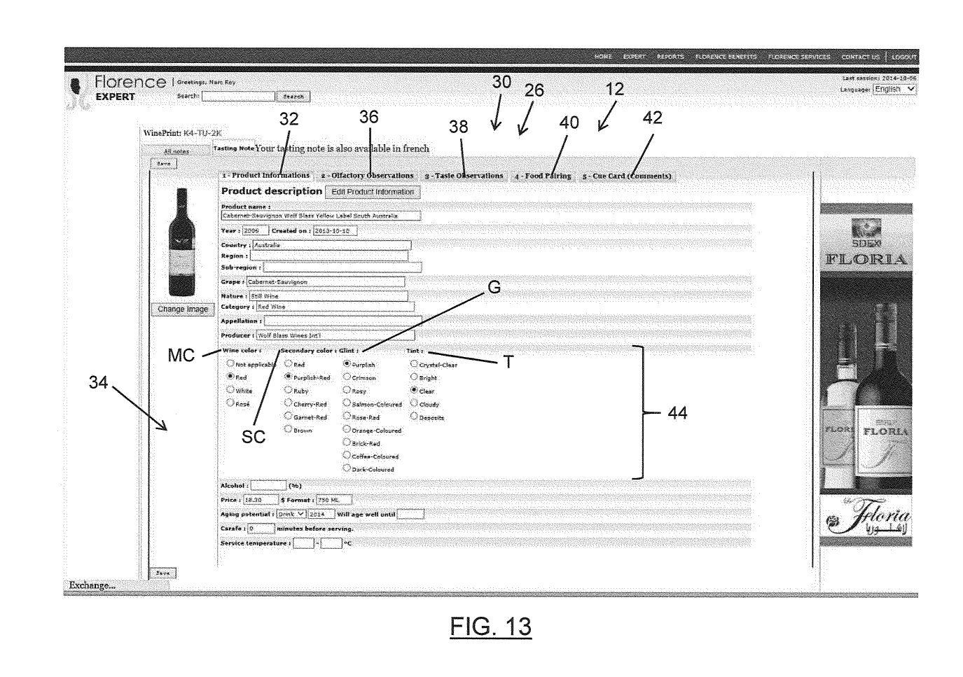

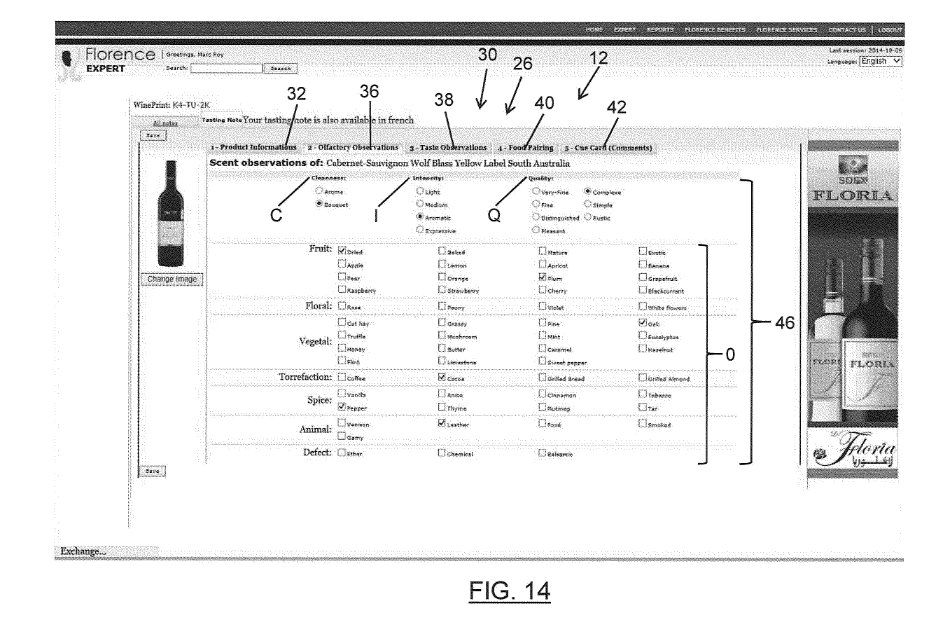

FIGS. 13 to 17 show data input screens of a tasting note for a wine, in accordance with another embodiment. This particular embodiment differs from the above-described embodiments in that some of the selectable attributes are different. FIG. 13 shows a ‘General Information’ tab 32 for data input which includes a Visual observations' section 34 and other features similar to those shown in FIG. 2. FIG. 14 illustrates an ‘Olfactory observations’ tab 36 and other features similar to those shown in FIG. 3.

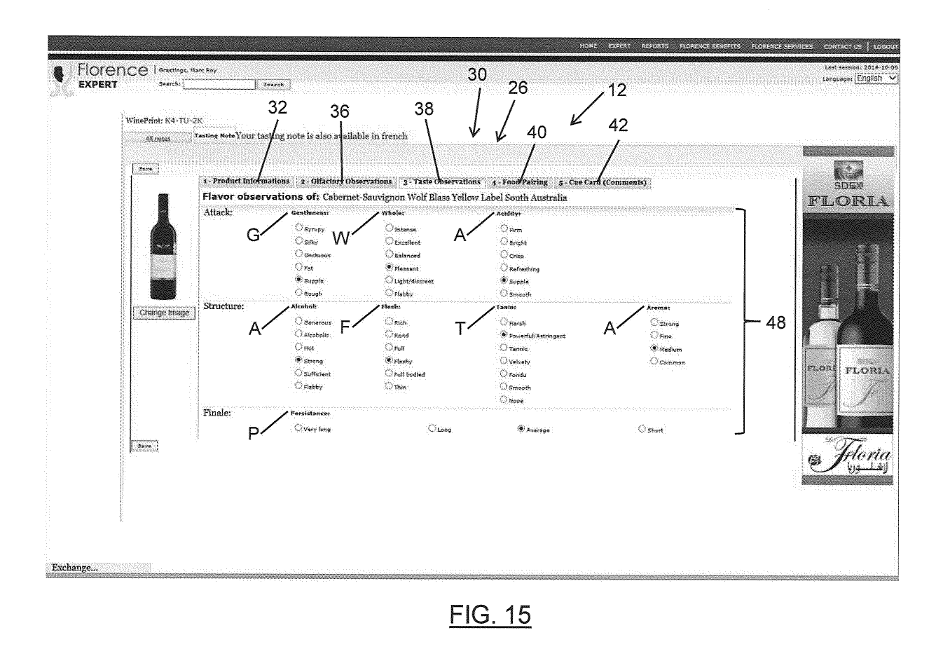

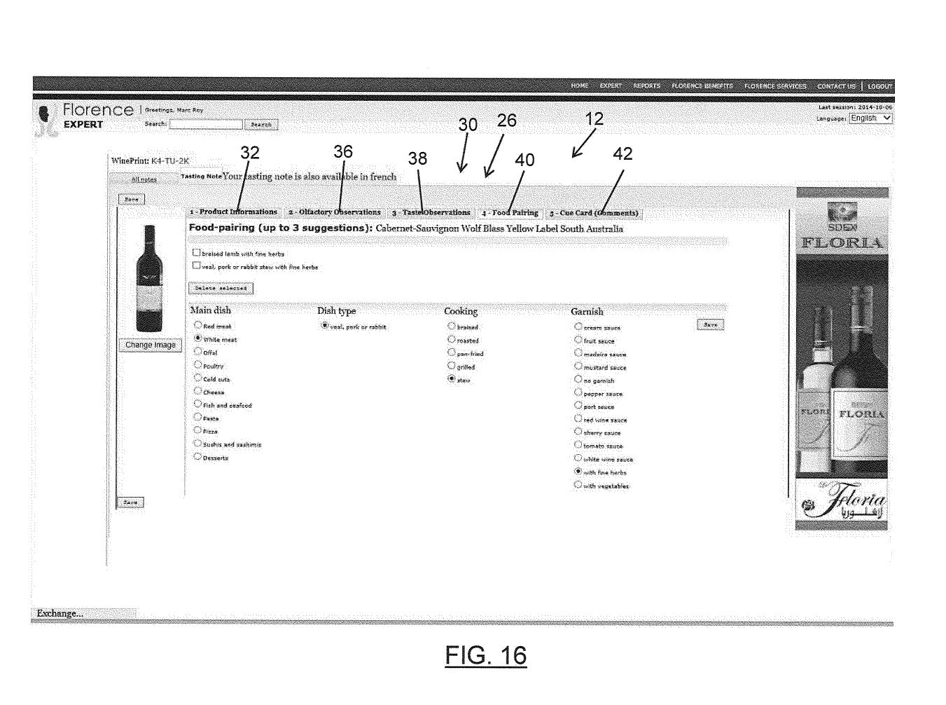

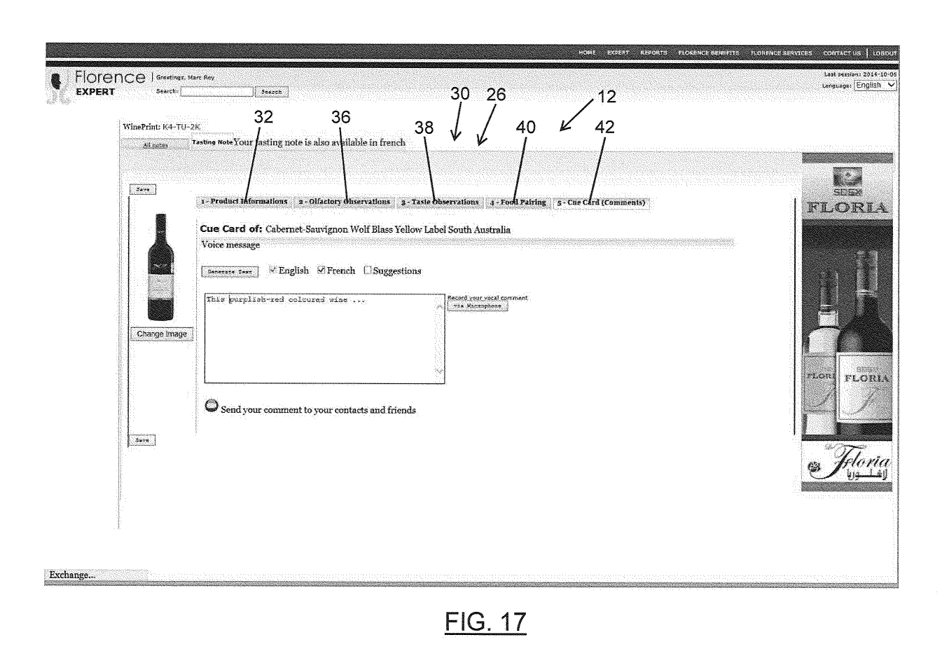

FIG. 15 illustrates a ‘Taste Observation’ tab 38 and other features similar to those shown in FIG. 4. FIG. 16 illustrates a ‘Food Pairing’ tab 40 and other features similar to those shown in FIG. 5. FIG. 17 illustrates a ‘Comments’ tab 42 and other features similar to those shown in FIG. 6.

The above-described embodiment is thus provided by a method for classifying food products, comprising, with reference to FIG. 1: receiving, in a memory 18, selected attributes (for example “Firm”) defining sensory properties (for example the Tanin) of the food product; correlating, by means of a processor 14, each selected attribute to a value; transforming the values of the attributes into a digest code, by means of a calculator 16 embedded in the processor 14, the digest code being a condensed and unique representation of the unique combination of said selected attributes defining the sensory properties; and storing in the memory 14, the digest code in association with the food product.

The method thus transforms the values to represent the unique combination of the selected attributes into a condensed and unique expression which is the digest code. In the above-described embodiment with reference to FIGS. 2 to 6, the digest code corresponds to the WinePrint Number (WPN or TPN), which is F9-MG-1 in the case of the Yellow Label™. The digest code may include a base component (or also referred to as main component), for example “F9-MG”. The digest code may further include an auxiliary component, for example “1” (in F9-MG-1) which is concatenated to the base component. The digest code may further include a variation component, for example “1” or “2” (in F9-MG-1-1 or F9-MG-1-2).

The sensory properties may include flavor property(ies), scent property(ies), visual property(ies), and/or any other suitable property(ies).

The correlating step comprises: defining parameters (example: Tanin, etc.) to characterize said sensory properties of the food product; and defining a set of possible attributes for each parameter (example: hard, firm, rough, smooth, fondu, petit, none). The possible attributes of a given parameter are mutually exclusive for a given food product, each possible attribute is associated to a position within the set of possible attributes (example: hard=position 1; firm=position 2; rough=position 3, etc.). For each selected attribute: an initial value is assigned to the selected attribute.

The initial value to be scaled is determined based on the position of the corresponding selected attribute within the set of possible attributes. The initial value is obtained by: providing a reference table (as shown in FIG. 12) in a memory associating each possible attribute to a unique numerical value; mapping each of the selected attributes to a unique numerical value based on the reference table; and obtaining said initial value, for each selected attribute, from the position of the numerical value within the list of numerical values associated in the reference table with the set of possible attributes for the corresponding parameter. Alternatively, the position information may be obtained for each attribute selected based on its position within the set of possible attributes.

This initial value is then scaled to a scaled value. a set of scaled values for each set of possible attributes is defined, each scaled value being associated to a position within the set of scaled values. More particularly, for a first set of scaled values, each scaled value corresponds to the position of the scaled value within the set; and then, for each subsequent set of scaled values, the first scaled value is set to the maximum scaled value of the previous set MAX_{PRECEDING SET} incremented by one, and each following scaled value is set to a sum of the maximum of the previous set MAX_{PRECEDING SET} and of the previous scaled value. For each selected attribute, the scaled value having a same position in the set of scaled values as the position of the selected attribute within the set of possible attributes of the parameter associated to the selected attribute is retrieved. In other words, the position of the selected attribute within the corresponding set of possible attributes is retained, and then the scaled value is set by retrieving the value having the same position in the set of scaled values, as the position of the selected attribute. The value of each selected attribute is then set to the corresponding scaled value.

The transforming step comprises summating the scaled values, and converting the sum of the scaled values (for example from a decimal numeral system to a base 36 system), in order to reduce the expression of the digest code.

### WinePrint Description

The WinePrint Description (WPD)—also referred to as a TastePrint Description (TPD)—is a short textual description of the main parameters of the FlavourPrint. The WinePrint Description is commonly used as a “Tool Tip” that is to say, a text appearing on the user interface screen when a user passes the mouse (without clicking) over a label on the screen representing a particular WinePrint. This structured and standardized text provides a commercial type description to each WP and WPN. As an example, a WPD of WPD “24-LR-1” may read “Wines belonging to 24-LR-1 are full-bodied and have a medium acidity. They are round in the mouth and the whole is excellent. These are dry wines with powerful aroma and pronounced alcohol”

### Wheel of Taste

The Wheel of Taste (WoT) is another important feature of the present system, in accordance with an embodiment thereof. It allows identifying products that are similar to a reference product, that is to say, products that share some of the characteristics of a given WinePrint. The taste should be different but relatively close to the reference product for which similar products are sought. The WoT is built by varying three parameters of FlavourPrint (taste axis); namely, Aroma (A) and/or Alcohol (Al) and/or Whole (W). Thus, one may vary the Aroma (A) parameter from strong to common, while keeping all other parameters at their initial attributes including the F parameter of the ScentPrint. Thus, a different WinePrint results, with similar characteristics to the reference WinePrint.

In accordance with the present embodiment, the WoT feature of the system offers the following levels to provide products similar to a given reference product:
At a first level, one of the following parameters is varied° Aroma (A), Alcohol (Al) and Whole (W). The similarity level is high, as the WinePrint represents a flavour that is very close to that of the reference product.
At a second level, two of the above-mentioned parameters are varied. The degree of similarity is lower than that of the first level, however, the flavours of the resulting WinePrints are still adjacent to that of the reference product.
At a third level, all three of the above-mentioned parameters are varied. The degree of similarity is even lower than that of the second level, however, this third level allows a consumer to discover products in the immediate vicinity of the reference product as other important parameters, namely Gentleness (Gs), Acidity (A) , Flesh (F), Tannin (T) (for red wine only), Persistence (P) and Olfactory family (F) in the ScentPrint are not changed.

An objective of the WoT is to introduce new products to consumers from a reference

WinePrint corresponding to a consumer's preference (or other reference). If he/she appreciates products from a resulting WinePrint, he/she may attempt to search similar products as the latter, which would lead to other adjacent WinePrints, hence the concept of a “Wheel of Taste”. Another objective of the WoT is to enable other stakeholders (such as agencies, wine producers, etc.) to increase positioning and referencing their products. As WoT is based on WinePrint, when a consumer sollicits the system to obtain products similar to a reference product, the resulting products share a similar taste, regardless of the grape variety(ies) and originating region(s). Indeed, products of different regions and/or different grape varieties may share a similar flavour.

### Expert Accuracy Index

The Expert Accuracy Index (EAI) is used to calculate an index of performance against the tasting notes made by wine experts. In other words, the system is capable of determining the best wine experts and eliminating “bad” tasting notes. Thus, when there are several wine experts who comment on a same product, the resulting tasting notes, from which emanate the WinePrint, come from “reference” wine experts.

Given tasting notes relating to a product, from several wine experts, a gap for each tasting note is calculated in relation to a target, namely the resulting WP. In other words, each expert is evaluated as to by how much they “missed the target”. This calculation takes into account all the parameters of the WinePrint. Thereafter, an overall average score is adjusted based on the calculated gaps. Thus, the EAI is an average of all scores by a wine expert for all its tasting notes. The more the EAI tends toward 0, the more the ratings of these wine experts are accurate.

When a wine expert creates a tasting note via the user interface, the system creates a corresponding WinePrint (i.e. a first WinePrint) and WinePrint Number. As other wine experts subsequently enter their tasting notes on the same product, the system generates corresponding WinePrint. The system then calculates a distance (or gap) in relation to the first WinePrint. Each subsequently generated WinePrint is compared, to all the other WinePrints, for a given wine product. This comparison involves all parameters of the WinePrint. Broadly, one WP is subtracted from another while involving the EAI. Namely, the distance between the WP of one expert (1) and the WP of another expert (2), is determined as follows:

Distance₁₋₂=(Weight_{EAI}×WP₁)−(Weight_{EAI2}×WP₂)

where Weight_{EA1}=1−EAI₁/(EAI₁+EAI₂),

and Weight_{EA2}=1−EAI₂/(EAI₁+EAI₂).

After all comparisons are made, Le. after all the distances are calculated, the system considers only the smallest distance. Thus, the two tasting notes having the smallest distance between them are considered to generate the WinePrint and WinePrint Number. Thereafter, the system recalculates the EAI for each wine experts involved in the evaluation.

Unlike conventional classification systems, the WinePrint Number is not a score, instead the WinePrint Number may be assimilated to a unique alphanumeric barcode identifying families of products having similar flavours.

The WinePrint system also does without requiring consumer enter scores. The system simply records the level of satisfaction of consumers regarding a particular product. The consumer is only required to taste products and enter their level of satisfaction, via the system's user interface 12, as illustrated in FIG. 10.

The system thus provides a WinePrint Number and dish pairing feature, which allows a consumer to enter food information and to request a suggestion of wine(s) to drink with this food. The system thus retrieves the consumer's favorite WinePrint Number(s) and attempts to offer from a set of products corresponding to the WinePrint Number(s), a product that enhances the entered food information. Wine pairings are predefined by wine experts using the system's user interface, via the ‘Food Pairing’ tab illustrated in FIG. 5.

The system's data is validated by wine experts recognized in their communities. Preferably, the data validation is on-going even during operation of the system.

Thus, the classification system, according to the embodiment described herein, provides a virtual wine steward, and more particularly an information system dedicated to stakeholders of the wine industry, including consumers. Thus the system provides a Business-to-Business (B2B) as well as a Business-to-Consumer (B2C) platform which meets industry needs for producers, retailers, and points of consumption, which offering a classification system independently of varieties, regions, etc.

Consumers may further request information on wine products through the system. They may express their appreciation and satisfaction levels. The system also offers consumers a virtual pantry and online shop connected in real time to wine shops to ensure product availability.

In addition, stakeholders such as agencies, wine producers, etc, may advertise their products and provide access to analytical reports containing various information, including their consumers' appreciation of their products. Since the system stores information on the appreciation given by consumers in association with a given WPN, a wine product belonging to this WPN may be advertised to all consumers who appreciate this WPN. Advantageously, the target market for a particular wine may be broadened in this way, rather than by targeting consumers on their appreciation of this particular wine product alone. Similarly, analytical reports may be produced on the basis of WPNs. For example, stakeholders may thus compare the positioning of their products regarding the overall products belonging to their respective WPN. The system uses a network of wine experts who comment on the various products through tasting notes.

Worded differently, there is provided, in accordance with embodiments, a method of classifying food products, comprising the steps of:
receiving, via a user interface, attributes defining at least flavour properties of one of said food products;
correlating, by means of a processor, each attribute to a value;
calculating a unique global value, by means of a calculator embedded in the processor, based on the values of each attribute, the unique global value being representative of the unique combination of flavour properties defined by the attribute values; and
associating in a database the unique global value to the food product.

Preferably, the unique total value is converted into a digest code, in order to facilitate comprehension and identification of the particular flavour combination having been defined. The code may be an alphanumeric code, a bar code, etc.

There may also be provided, is provided, according to embodiments, a classification system for food products, comprising:
a user interface for receiving attributes defining flavour properties of one of said food products;
a processor communicating with the user interface, for correlating each attribute to a value;
a calculator embedded in the processor for calculating a unique global value based on the values of each attribute, the unique global value being representative of the unique combination of flavour properties defined by the attribute values; and
a database for storing the unique global value in association with the food product.

It is to be understood that the above-described classification system and method may be easily adapted to other food products or beverages, such as beer, cheese, yogurt, meat, etc. in order to categorize such food products and/or beverages based on their sensory properties. For example, instead of a WinePrint, the system may be based on a CheesePrint or ChocolatePrint, as can be readily understood by the person skilled in the art. Similarly, a ChessePrint Number or a ChocolatPrint Number may be obtained using the mathematical and algorithmic models similar to that described herein with respect to the WinePrint Number.

The above-described embodiments are considered in all respect only as illustrative and not restrictive, and the present application is intended to cover any adaptations or variations thereof, as apparent to a person skilled in the art. Of course, numerous other modifications could be made to the above-described embodiments without departing from the scope of the invention, as apparent to a person skilled in the art.

1. A method for classifying food products, comprising the steps of:
receiving, in a memory, selected attributes defining sensory properties of one of said food products;
correlating, by means of a processor, each selected attribute to a value;
transforming the values of the attributes into a digest code, by means of a calculator embedded in the processor, the digest code being a condensed and unique representation of the unique combination of said selected attributes defining the sensory properties; and
storing in the memory, the digest code in association with the food product.

2. The method according to claim 1, wherein the correlating step comprises for each selected attribute:
assigning an initial value to the selected attribute;
scaling said initial value to a scaled value; and
setting said value of the selected attribute to the corresponding scaled value.

3. The method according to claim 2, wherein the correlating step further comprises:
defining parameters to characterize said sensory properties of the food product; and
defining a set of possible attributes for each parameter, the possible attributes of a given parameter being mutually exclusive for a given food product, each possible attribute being associated to a position within the set of possible attributes;
wherein the initial value to be scaled is determined based on the position of the corresponding selected attribute within the set of possible attributes.

4. The method according to claim 3, wherein the initial value is obtained by:
providing a reference table in a memory associating each possible attribute to a unique numerical value;
mapping each of the selected attributes to a unique numerical value based on the reference table; and
obtaining said initial value to be scaled, for each selected attribute, from the position of the numerical value within the list of numerical values associated in the reference table with the set of possible attributes for the corresponding parameter.

5. The method according to claim 3, wherein the scaling comprises:
defining a set of scaled values for each set of possible attributes, each scaled value being associated to a position within the set of scaled values; and
for each selected attribute, retrieving the scaled value having a same position in the set of scaled values as the position of the selected attribute within the set of possible attributes of the parameter associated to the selected attribute.

6. The method according to claim 5, wherein the step of defining the set of scaled values comprises:
for a first set of scaled values, setting each scaled value to the position of the scaled value within the set; and
for each subsequent set of scaled values, setting the first scaled value to the maximum scaled value of the previous set MAX_{PRECEDING SET} incremented by one, and setting each following scaled value to a sum of the maximum of the previous set MAX_{PRECEDING SET} and of the previous scaled value.

7. The method according to claim 2, wherein the transforming step comprises summating the scaled values to obtain the digest code.

8. The method according to claim 7, wherein the transforming further comprises converting a sum of the scaled values resulting from the summating step, in order to reduce the expression of the digest code.

9. The method according to claim 8, wherein said sum of the scaled values is converted from a decimal numeral system to a base 36 system.

10. The method according to claim 1, wherein said sensory properties include flavor properties of the food product.

11.-12. (canceled)

13. The method according to claim 1, wherein the digest code comprises a base component representing said selected attributes.

14. The method according to claim 13, further comprising receiving additional selected attributes defining auxiliary sensory properties of said food product, the digest code further comprising an auxiliary component concatenated to said base component representing a unique combination of the additional attributes having been selected to define the food product.

15. The method according to claim 13, wherein the digest code further comprises a variation component representing a variation of a food product in relation to other food products sharing similar ones of said selected attributes.

16.-21. (canceled)

22. The method according to claim 1, wherein said sensory properties include one or more flavor parameter, the digest code comprising a base component representing the selected attributes of said one or more flavor parameter.

23.-29. (canceled)

30. The method according to claim 1, wherein the digest code comprises alpha-numerical characters.

31. The method according to claim 30, wherein the digest code is defined by five alpha-numerical characters.

32. A processor-readable storage medium for classifying food products, the processor-readable product comprising data and instructions for execution by a processor, to execute the steps of the method, in accordance with claim 1.

33. A processor-readable storage medium according to claim 32 wherein the processor-readable storage medium is a non-transitory product.

34. A system for classifying food products, the system comprising:
a memory for receiving selected attributes defining sensory properties of each of said food products;
a processor being in communication with the memory for correlating each selected attribute of said food product, to a value; and
a calculator embedded in the processor, for transforming the values of the selected attributes of said food product, in order to represent the unique combination of said selected attributes into a condensed and unique digest code to be stored in the memory in association with the food product.

35. The system according to claim 34, further comprising a user interface device adapted to communicate with the processor, in order to display said digest code in association with the food product.
